(19) United States
(12) Patent Application Publication
(10) Pub. No.: US 2005/0040659 A1
(43) Pub. Date: Feb. 24, 2005

(54) Furniture

(75) Inventors: Mark Andrew Baker, High Wycombe (GB); Colin William Clinch, Basingstoke (GB); Jonathan Thurlbourne, Sudbury (GB); Richard A. Nelson, Napoleon, OH (US); Terry W. Armey, Napoleon, OH (US); Troy E. Tedrow, Wauseon, OH (US); Brian D. Fritch, Stryker, OH (US)

Correspondence Address: TAROLLI, SUNHEIM, COVELL, TUMMINO & SZABO, 111 LEADER BLDG., CLEVELAND, OH, 44114-1400, US

(73) Assignees: Titus International plc; Sauder Woodworking Co.

(21) Appl. No.: 10/644,127

(22) Filed: Aug. 20, 2003

(51) Int. Cl. E05C 17/44

(52) U.S. Cl. 292/338

(57) ABSTRACT

A drawer locking device for locking a plurality of drawers has respective blocking devices for blocking movement of the drawers and a connector connecting the blocking devices such that movement of any of the blocking devices caused by opening of the respective drawer causes a corresponding movement of each remaining blocking device to respective positions in which opening of the respective drawers is blocked. A method of assembling the drawer locking device comprises connecting the blocking devices with a furniture item at respective reference positions provided on the furniture item and fixing the connector to the blocking devices when they are connected with the respective reference positions. This provides a drawer locking device in which the blocking devices are fixed to the connector at spaced positions determined by the reference positions. The drawer locking device can then be disconnected from the item of furniture for refitting in an operative position.

### BACKGROUND TO THE INVENTION

This invention relates to locking mechanisms for furniture items having multiple drawers.

Locking mechanisms are known which prevent the opening of more than one drawer in a filing cabinet at any one time. This is to prevent the possibility of the cabinet over-balancing and toppling forward. Such mechanisms typically comprise a series of latching devices which are controlled by an actuator upon opening movement of one drawer to block opening movement of the other drawers. There is an increasing need for such locking mechanisms to be fitted to other items of furniture which feature multiple drawers, such as desks or chests of drawers. Difficulties arise when designing such locking mechanisms to operate on drawer systems which cater for different size drawers or which allow for adjustable positioning of their drawers.

### SUMMARY OF THE INVENTION

The invention provides a locking mechanism for an item of furniture having two or more drawers and means mounting the drawers for openable and closable movement, in which each drawer has associated with it a latching device co-operable with the furniture item to allow opening movement of the drawer in a first position of the latching device and to prevent said opening movement in a second position of the latching device, there being a connecting member linking together the latching devices of all the drawers such that opening of any one of the drawers causes the latching devices of all the other drawers to move to their second position, whilst closure of said one drawer causes the latching devices of all the other drawers to return to their first position, wherein the latching devices are connectable to said connecting member at positions to be determined by reference to fixed points on the furniture item for the drawer mounting means.

The invention also includes a method of assembling a drawer locking device for an item of furniture comprising a plurality of drawers, said drawer locking device comprising respective blocking devices for blocking movement of said plurality of drawers and a connector for connecting said blocking devices such that movement of any one of said plurality of blocking devices caused by opening of the respective drawer causes a corresponding movement of each of the remaining said blocking devices to respective positions in which opening of the respective drawers is blocked, said method comprising connecting said blocking devices with said furniture item at respective reference positions provided in said furniture item, fixing said connector to said blocking devices when said blocking devices are connected with said furniture item at said respective reference positions to provide a drawer locking device in which said blocking devices are fixed to said connector at spaced apart positions determined by said reference positions and disconnecting said drawer locking device from said item of furniture for fitting to said item of furniture in an operative position.

The invention also includes a drawer locking device for an item of furniture having a plurality of drawers, said locking device comprising a plurality of blocking devices each of which, in use, is movable between a first position permitting opening of a respective drawer and a second position in which opening of the respective drawer is blocked, and a connecting member for connecting said blocking devices such that movement of any one of the blocking device causes a similar movement of each other blocking device, said blocking devices each having a first connecting portion for releasable connection with respective reference connections associated with each drawer in said furniture item and a second connecting portion for connection with said connecting member, the arrangement being such that said connecting member can be connected to said second connecting portions of said blocking devices when said blocking devices are connected with said reference connections by said first connecting portions whereby said blocking devices are connected to said connecting member with a spacing substantially determined by said reference connections.

### BRIEF DESCRIPTION OF THE DRAWINGS

By way of example, an embodiment of the invention will now be described with reference to the accompanying drawings, in which:

FIG. 1 is a schematic, part-sectional view of a filing cabinet incorporating a locking mechanism according to the present invention,

FIG. 2 shows the actuator track of the FIG. 1 mechanism,

FIGS. 3a and 3b shows the design of the latching device of the FIG. 1 mechanism,

FIG. 4 shows the design of the pin member of the FIG. 1 mechanism, and

FIGS. 5a and 5b are diagrammatic illustrations showing how the pin members and latching devices co-operate in use.

### DESCRIPTION OF PREFERRED EMBODIMENTS

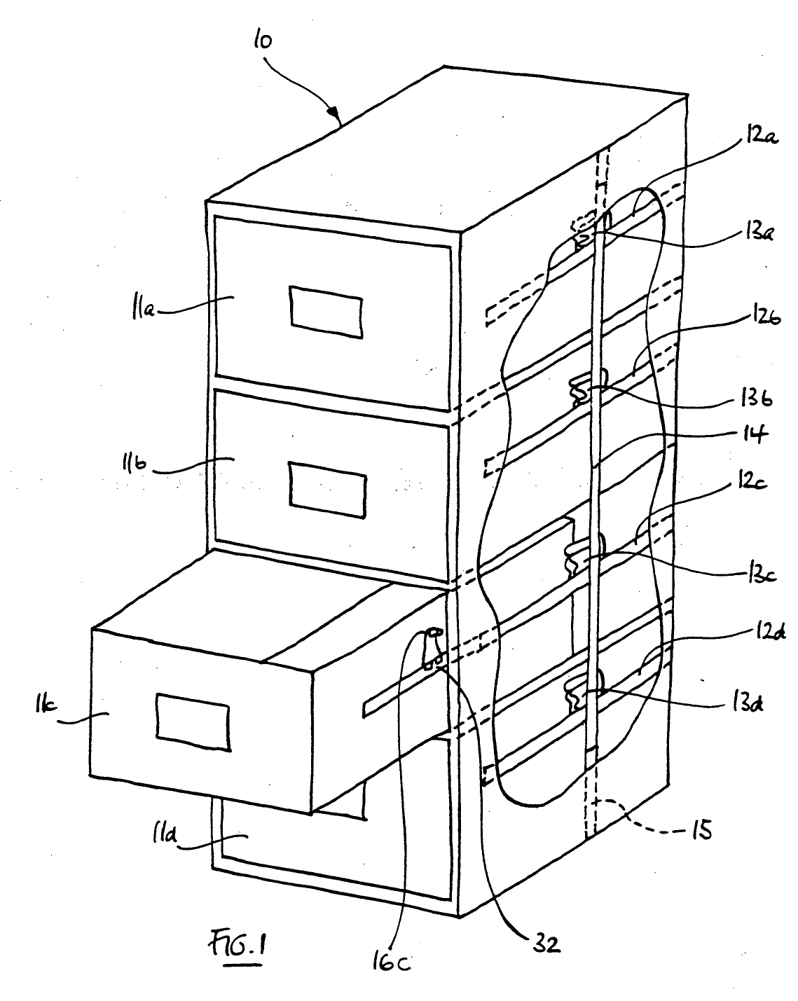

FIG. 1 shows a typical filing cabinet 10 with a number of drawers 11a, 11b, 11c, 11d. Each of the drawers is arranged for horizontal opening and closing movement relative to the cabinet via a pair of drawer runners 12a, 12b, 12c, 12d on either side of the drawer. Drawer runners for this purpose are well known and typically comprise a pair of generally channel-shaped tracks, one of which is connected to the side of the drawer and the other of which is connected to the inside of the cabinet. Rolling elements such as wheels or ball bearings are captured between the tracks to mount the drawer for rolling movement and to provide support for the weight of the drawer when it is open.

The inside faces of the cabinet and the outside faces of the drawer sides are pre-drilled with a standard pattern of holes for attaching the drawer runners, usually by means of screws. These hole patterns ensure that when the cabinet is assembled, typically by the consumer at home, the runners are set at the correct spacing and alignment for the drawers.

The cabinet seen in FIG. 1 features a locking mechanism for the drawers. The locking mechanism is designed to ensure that only one drawer can be opened at any given time. The mechanism comprises a series of latching devices 13a, 13b, 13c, 13d, each of which is associated with a respective drawer 11a, 11b, 11c, 11d, with the latching devices all being connected together via a connecting member 14. The connecting member, with all the latching devices attached, is arranged for slidable movement up and down a groove 15 on the inside face of the cabinet 10.

The latching devices 13a, 13b, 13c, 13d are engagable by pins associated with each respective drawer (only pin 16c is seen in FIG. 1). In use, when all the drawers are closed, the pins 16 and their associated latching devices 13 are in non-interfering engagement, i.e. any one of the drawers is free to be opened. As soon as one of the drawers is opened, however, movement of that drawer's pin causes its associated latching device to move upwardly. This upward movement of the one latching device is translated via the connecting member 14 to the latching devices of all the other drawers. When all these other latching devices move upwardly in this way, they move into an interfering engagement with their respective pins, i.e. in a sense to block opening movement of their associated drawers. The latching devices are all returned to their original non-interfering position when the drawer first opened is subsequently closed. This is explained in more detail with reference to FIGS. 5a and 5b.

One of the difficulties when designing locking mechanisms of this nature is to enable them easily to be adapted to be used with different numbers, sizes and configurations of drawer systems, whilst still remaining relatively simple to assemble and reliable in use. To that end, the connecting member 14 here has been designed as an extruded plastics track to which the latching devices 13 can be fitted by hand with a simple snap action. By this means, the particular number and spacing of latching devices on the connecting member can be tailored to any number of different settings, suiting a wide range of different furniture applications.

As seen in FIGS. 3a and 3b, each latching device 13 is provided with a peg 17 on its front face. The peg 17 is designed to be insertable into one of the standard pre-drilled holes in the cabinet 10 for the drawer runners 12. On its rear face, each latching device 13 has an arrangement of flexibly resilient feet 18 into which the connecting member 14 can be snap-fitted. In practice, all an assembler has to do before fitting the drawers 11 is place a latching device 13 by its peg 17 in each of the pre-drilled holes, line up the connecting member 14 with all of the latching devices and then press the track into engagement with each device. The connecting member 14 will now have all of the latching devices 13a, 13b, 13c, 13d fixed to it at exactly the right relative pitching. The connecting member 14, with the latching devices 13 all attached, is then turned over and put into the groove 15 in the cabinet 10. When the drawer runners 12 are then fixed to the cabinet 10 in the usual way, the connecting member 14 is captured in the groove 15. The groove 15 is sized to receive the connecting member 14, with all the latching devices 13 attached, for free slidable movement up and down, whilst providing constraint against lateral movement (subject to a small amount of “play”).

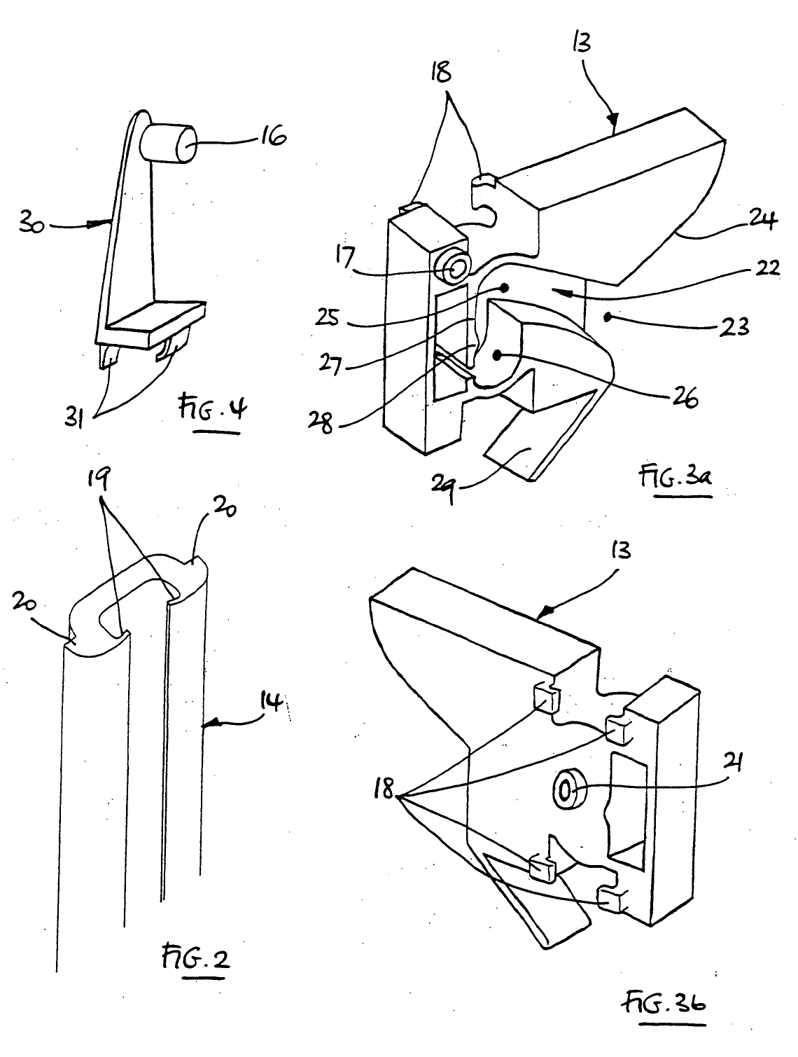

FIGS. 2 and 3a and 3b show in more detail the design of the connecting member 14 and latching device 13.

As seen in FIG. 2, the connecting member 14 is a generally U-shaped channel section, conveniently formed as a plastics extrusion. The section features a pair of inwardly facing lips 19 on the inside of the “U” and a pair of flanges 20 on the outside of the “U”.

As seen in FIGS. 3a and 3b, the latching device 13, which is conveniently in the form of a moulded plastics part, is designed with an arrangement of resiliently flexible feet 18 to enable it to be clipped to the connecting member 14 via the flanges 20. This arrangement includes a boss 21. The boss 21 has a diameter which is slightly larger than the space between the inwardly facing lips 19 of the connecting member 14. This means that when the latching device 13 is clipped onto the connecting member 14, the feet 18 engage the flanges 20, and the boss 21 engages between the lips 19 with an interference fit. This serves to ensure that the latching device 13 is securely fixed in position on the connecting member 14. It will be noted that the arrangement allows the latching device 13 to be positioned on the connecting member 14 in any desired location and even, if necessary, disconnected and re-fitted in a different location.

The main body of the latching device 13 contains a contoured guideway 22 for slidable receipt of the pin 16 connected to its associated drawer 11. As will be seen, the guideway 22 has an entrance 23 below an angled face 24 of the body. From the entrance 23, the guideway 22 extends upwardly at an acute angle to a backward position 25, from which it then extends downwardly to a pocket 26. The wall of the guideway 22 just above the pocket 26 is formed with a spring finger 27, with a small rounded protrusion 28 extending into the guideway. When the latching device 13 is moved upwardly relative to its associated pin 16, the pin moves into the pocket 26, resiliently biasing the spring finger 27 on its way as it does so. The spring finger 27 returns to its original position when the pin 16 sits in the pocket 26, thereby holding the pin in that position. This is enough to hold the connecting member 14, with all the latching devices 13 attached, in its blocking position, i.e. preventing it from falling back to its unblocking position under gravity.

The body of the latching device 13 also features a spacer 29. The purpose of this spacer 29 is to pick up on the runner 12 of the drawer 11 and thereby distance the latching device 13 by the appropriate amount from this level. This sets the latching device 13, and in particular the entrance 23 to its guideway 22, at the correct level to engage its associated pin 16.

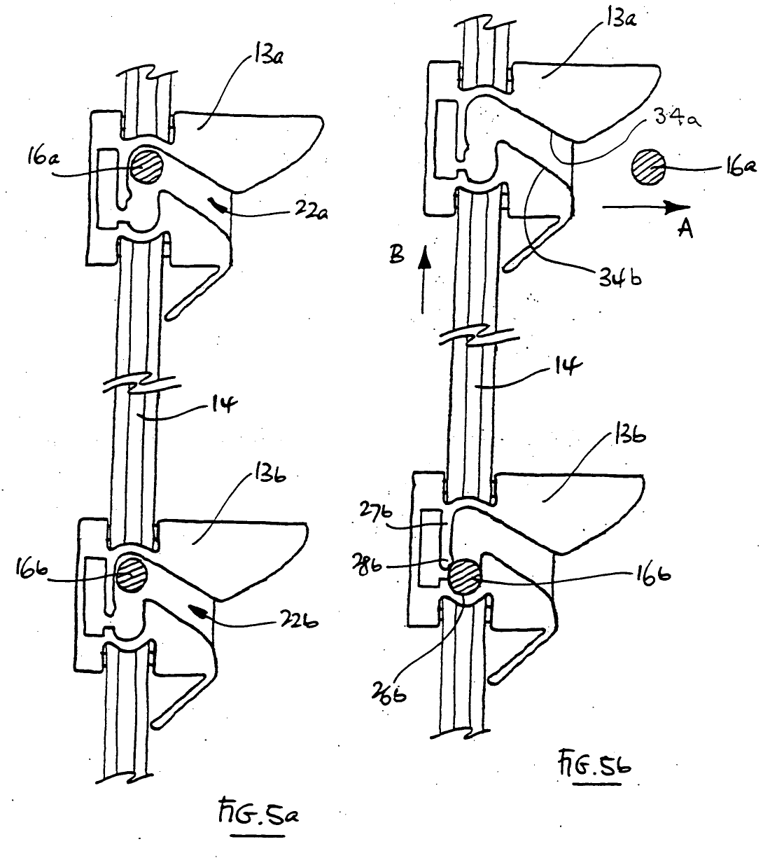

The pin 16 for each drawer 11 may simply take the form of a dowel or peg fitted in a suitable hole pre-drilled in the side of the drawer. With such arrangements, the exact position of the pins is governed by the pre-drilling and the latching device can be designed accordingly so as to engage it properly. Nowadays, however, drawer runners have come on to the market which allow for some vertical adjustment of the drawer relative to its runners. With such arrangements, it may no longer be appropriate to use pins that are fixed to the drawers, because their exact position relative to the cabinet may vary, in some instances by more than an allowable tolerance, with the result that the locking mechanism will not work properly. As an alternative, therefore, as seen in FIG. 4, a pin member 30 is provided which is designed to clip onto the drawer-side rail of the drawer runner 12. The drawer-side rail of the drawer runner 12 remains at a fixed level relative to the cabinet 10 even if the position of its associated drawer 11 is adjusted.

As seen in FIG. 4, the pin member 30 has an upstanding body from which pin 16 extends out at the top and from which an arrangement of resiliently flexible feet 31 extend down at the bottom. The feet 31 are designed to engage in pre-formed holes 32 in the drawer-side track of the drawer runner 12 by means of a snap action. The precise location of the pin 16 along the length of the drawer runner 12 is accurately determined by the pre-formed holes 32 and the fixing arrangement means that the pin member 30 is held fast in this position.

FIGS. 5a and 5b illustrate schematically how the pins 16a, 16b of two drawers co-operate with their associated latching devices 13a, 13b. FIG. 5a shows the position where the two drawers are closed. The pins 16a, 16b are engaged in the guideways 22 of their associated latching devices 13a, 13b. In this position, either drawer is free to open. FIG. 5b shows the position after the upper drawer has been opened in the direction of arrow A. The upper pin 16a has moved in the direction of arrow A together with its associated drawer. This lateral movement of the upper pin 16a has acted on the ramped surface 33a of the guideway 22a of its associated latching device 13a, causing the latching device to move upwardly in the direction of arrow B. Latching device 13a moves upwardly because it is attached to the connecting member 14, which is itself constrained to move up or down in its groove in the inside face of the cabinet. Since the lower latching device 13b is also attached to the connecting member 14, this also moves upwardly in the direction of arrow B by the same amount. As will be seen, the upward movement of the lower latching device 13b in FIG. 5b means that the pin 16b of its associated drawer is now located in the pocket 26b of the guideway 22b of its associated latching device 13b. In this position, the pin 16b is unable to move laterally. Thus, the lower drawer is prevented from opening. The connecting member 14, with the two latching devices 13a, 13b attached, is held in this upper position by means of the protrusion 28b on the spring finger 27b in the lower latching device.

When the upper drawer is closed again, it will be seen that its associated pin 16a will move in a direction opposite to arrow A and strike the opposite ramped surface 34b of the guideway 22a of its associated latching device 13a, causing the latching device to move downwardly again, together with, via the connecting member 14, the lower latching device 13b. The locking mechanism thus returns to the position shown in FIG. 5a.

If desired, the furniture item may include means operable by a key for locking all the drawers. This would operate simply to move the connecting member upwardly so that each pin is seated in the pocket of its associated latching element, thereby blocking movement of all the pins and their associated drawers.

It will be appreciated that the drawer locking mechanism is intended primarily for use in knock-down furniture and the process of fitting the latching devices to the connecting member will normally take place prior to assembly of the furniture item using a component of the furniture item that has been provided with fixing holes for the drawer runners. Preferably the actual fixing holes will be used for locating the latching devices while the connecting member is connected to them. However, it is possible, although not preferred, to provide dedicated reference holes at predetermined distances from the fixing holes.

It is to be understood that numerous variations and modifications to the preferred embodiments of the invention may be made by those skilled in the art without departing from the spirit and scope of the invention as defined in the appended claims.

1. A locking mechanism for an item of furniture having two or more drawers and means mounting the drawers for openable and closable movement, in which each drawer has associated with it a latching device co-operable with the furniture item to allow opening movement of the drawer in a first position of the latching device and to prevent said opening movement in a second position of the latching device, there being a connecting member linking together the latching devices of all the drawers such that opening of any one of the drawers causes the latching devices of all the other drawers to move to their second position, whilst closure of said one drawer causes the latching devices of all the other drawers to return to their first position, wherein the latching devices are connectable to said connecting member at positions to be determined by reference to fixed points on the furniture item for the drawer mounting means.

2. A locking mechanism as claimed in claim 1 wherein said latching devices are releasably connectable to said connecting member.

3. A locking mechanism as claimed in claim 2 where in said latching devices are connectable to the connecting member by means of a snap fit.

4. A locking mechanism as claimed in claim 1 wherein each latching device has a peg or the like to register with a preformed hole in the furniture item corresponding to a respective drawer mounting means and said latching devices are designed to be connectable to the connecting member whilst their pegs are registered in respective said preformed holes.

5. A locking mechanism as claimed in claim 1 wherein said connecting member is designed to be located for slidable movement in a preformed groove in the furniture item.

6. A locking mechanism as claimed in claim 1 wherein each said latching device is arranged to cooperate with a pin associated with its respective drawer.

7. A locking mechanism as claimed in claim 6 wherein the drawers are mounted to the furniture item in non-adjustable positions and each pin is mounted on its associated drawer.

8. A locking mechanism as claimed in claim 1 wherein the drawers are mounted to the furniture item in adjustable positions and each pin is mounted on the drawer mounting means of its associated drawer.

9. A locking mechanism as claimed in claim 8 wherein said drawer mounting means are configured for receiving said mount for their respective pins at a chosen position.

10. A locking mechanism as claimed in claim 8 wherein said pins are mounted to their respective drawer mounting means by means of a snap fitting.

11. A locking mechanism as claimed in claim 1 wherein the mechanism is operable additionally and selectively to disallow opening movement of all the drawers.

12. A furniture item comprising a locking mechanism as claimed in claim 1.

13. A method of assembling a drawer locking device for an item of furniture comprising a plurality of drawers, said drawer locking device comprising respective blocking devices for blocking movement of said plurality of drawers and a connector for connecting said blocking devices such that movement of any one of said plurality of blocking devices caused by opening of the respective drawer causes a corresponding movement of each of the remaining said blocking devices to respective positions in which opening of the respective drawers is blocked, said method comprising connecting said blocking devices with said furniture item at respective reference positions provided in said furniture item, fixing said connector to said blocking devices when said blocking devices are connected with said furniture item at said respective reference positions to provide a drawer locking device in which said blocking devices are fixed to said connector at spaced apart positions determined by said reference positions and disconnecting said drawer locking device from said item of furniture for fitting to said item of furniture in an operative position.

14. A method as claimed in claim 13, wherein said reference positions are defined by respective holes provided in said furniture item for assembly of respective drawer runners for said plurality of drawers.

15. A method as claimed in claim 13, wherein said reference positions are defined by respective drawer runners for said plurality of drawers.

16. A drawer locking device for an item of furniture having a plurality of drawers, said locking device comprising a plurality of blocking devices each of which, in use, is movable between a first position permitting opening of a respective drawer and a second position in which opening of the respective drawer is blocked, and a connecting member for connecting said blocking devices such that movement of any one of the blocking device causes a similar movement of each other blocking device, said blocking devices each having a first connecting portion for releasable connection with respective reference connections associated with each drawer in said furniture item and a second connecting portion for connection with said connecting member, the arrangement being such that said connecting member can be connected to said second connecting portions of said blocking devices when said blocking devices are connected with said reference connections by said first connecting portions whereby said blocking devices are connected to said connecting member with a spacing substantially determined by said reference connections.

17. An item of furniture comprising a drawer locking device as claimed in claim 16.
